(19) United States
(12) Patent Application Publication
(10) Pub. No.: US 2006/0182297 A1
(43) Pub. Date: Aug. 17, 2006

(54) Garment with water-resistant speakers

(75) Inventors: Terry John Cyr, San Francisco, CA (US); Theodore Charles Sorom, San Francisco, CA (US)

Correspondence Address: FROST BROWN TODD, LLC, 2200 PNC CENTER, 201 E. FIFTH STREET, CINCINNATI, OH, 45202, US

(73) Assignee: Wild Planet Toys, Inc.

(21) Appl. No.: 11/340,159

(22) Filed: Jan. 26, 2006

Related U.S. Application Data
(60) Provisional application No. 60/652,978, filed on Feb. 15, 2005.
(60) Provisional application No. 60/734,221, filed on Nov. 7, 2005.

(51) Int. Cl. H04R 9/06; H04R 5/02; H04R 1/02

(52) U.S. Cl. 381/333; 381/301; 381/388

(57) ABSTRACT

A wearable sound system comprises a garment and a speaker assembly. The system may further comprise an audio device. In one embodiment, the audio device and the speaker assembly are detachably mounted to the garment. In another embodiment, the speaker assembly is integral with the garment. The speaker assembly may comprise a fabric member positioned between a front and rear member, such that the fabric member may be secured to the garment. The audio device and/or the speaker assembly may be substantially water resistant, such that the garment may be washed with the components without damaging the components. The garment may be a hooded garment, a backpack, or any other garment.

### PRIORITY

This application claims priority from the disclosure of U.S. Provisional Patent Application Ser. No. 60/652,978, entitled “Hooded Garment with Integral Speakers and Audio Player Interface,” filed Feb. 15, 2005, the disclosure of which is incorporated by reference herein. This application also claims priority from the disclosure of U.S. Provisional Patent Application Ser. No. 60/734,221, entitled “Garment with Water-Resistant Speakers,” filed Nov. 7, 2005, the disclosure of which is incorporated by reference herein.

### BACKGROUND OF THE INVENTION

A variety of electronic devices such as radios have been incorporated into a variety of garments. Several such devices have been configured to resist water. Such devices have also been configured to interface with garments in a variety of ways. However, no one prior to the inventors has created or used the invention described in the appended claims.

### BRIEF DESCRIPTION OF THE DRAWINGS

While the specification concludes with claims that particularly point out and distinctly claim the invention, it is believed the expressly disclosed exemplary embodiments of the present invention can be understood from the following description taken in conjunction with the accompanying drawings, in which like reference numerals identify the same elements. The drawings and detailed description which follow are intended to be merely illustrative of the expressly disclosed exemplary embodiments and are not intended to limit the scope of the invention as set forth in the appended claims. In the drawings:

FIG. 1 is a perspective view of a garment having a detachable audio device, a control panel, integral wiring, and detachable earphone speakers;

FIG. 2 is a partial front view of the control panel of FIG. 1;

FIG. 3 is a partial front view of the detachable audio device of FIG. 1;

FIG. 4 is a partial exploded rear view of the detachable audio device of FIG. 1;

FIG. 5 is a partial perspective view of the detachable audio device of FIG. 1 and a device mounting plate;

FIG. 6 is a partial perspective view of one of the detachable earphone speakers of FIG. 1 and a speaker mounting plate;

FIG. 7 is a partial perspective view of various components of one embodiment;

FIGS. 8A and 8B are a schematic circuit diagram of one embodiment;

FIG. 9 is a perspective view of a garment with a pocket held audio player, a control panel, integral wiring, and washable attached headphone speakers;

FIG. 10 is an exploded perspective front view of one of the washable attached headphone speakers of FIG. 9;

FIG. 11 is an exploded perspective back view of the pocket held audio player of FIG. 9;

FIG. 12 is an exploded perspective view of an alternative washable attached headphone speaker for the garment of FIG. 9;

FIG. 13 is a perspective view of a hood incorporating a headphone speaker;

FIG. 14 is a cross sectional view of the headphone speaker of FIG. 13 taken along lines 14-14; and

FIG. 15 is a front view of a backpack incorporating the headphone speaker of FIG. 13 in shoulder straps along with integral wiring and pouch for holding an audio player.

### DETAILED DESCRIPTION OF THE INVENTION

The following description should not be used to limit the scope of the present invention. Other examples, features, aspects, embodiments, and advantages of the invention will become apparent to those skilled in the art from the following description, which includes by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive. It should therefore be understood that the inventors contemplate a variety of embodiments that are not explicitly disclosed herein.

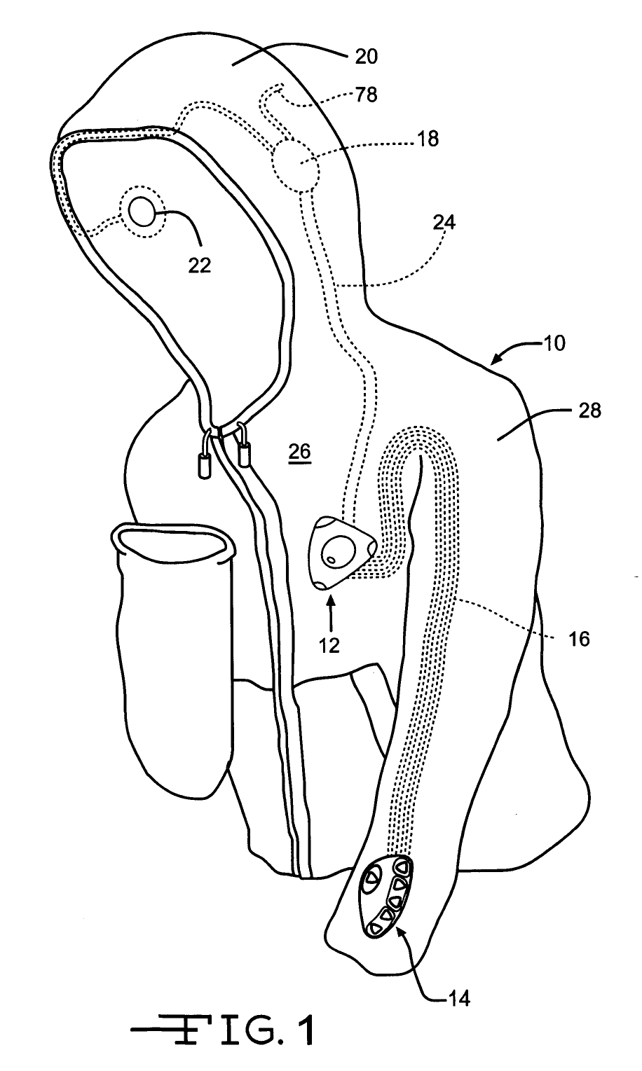

FIG. 1 shows an embodiment of a garment 10 in the form of a hooded jacket.

Of course, a garment 10 may comprise many other shapes and materials. An electronic radio device 12 is mounted on garment 10. In the present example, electronic radio device 12 is detachably mounted to garment 10, as will be described in more detail below. Alternatively, electronic device may be permanently mounted to garment 10 or otherwise provided.

In the present example, electronic radio device 12 comprises an FM radio.

However, it is understood that radio device 12 could comprise several other types of electronic devices, including but not limited to mp3 players, RealAudio® players, minidisk players, cassette players, satellite radio, compact disc players, IPODs, DVD players, etc.

A control panel 14 is also attached to garment 10. Control panel 14 is adapted to receive input from the user in order to control radio device 12. As shown in FIG. 1, control panel 14 is mounted on the wrist area of garment 10. In this position, it may be convenient for users to operate the radio device 12. However, it is recognized that control panel 14 may be mounted at various other locations on garment 10 or located elsewhere. In the present example, input is communicated from control panel 14 to radio device 12 by connectors 16.

Garment 10 of the present example further comprises speaker assemblies 18.

In one embodiment, speaker assemblies 18 are at least partially contained within the fabric of garment 10, and speaker assemblies 18 are therefore represented by dashed lines in FIG. 1. As shown, speaker assemblies 18 are located in a hood 20 of garment 10. Of course, speaker assemblies 18 may be located elsewhere. A screen 22 is optionally provided in order to facilitate passage of sound from speaker assemblies 18 through the fabric of garment 10. Speaker assemblies 18 of this example receive output from radio device 12 by connectors 24. In one embodiment, speaker assemblies 18 are substantially water resistant, such that speaker assemblies 18 may be washed without causing damage to speaker assemblies 18. For instance, speaker assemblies 18 may incorporate O-rings (not pictured) and/or other features to provide or enhance water resistance. Several other configurations to providing water resistance will be described below, while others will be apparent to those of ordinary skill in the art.

Connectors 16 and connectors 24 may be located within the fabric of garment 10 or on the inner surface of garment 10, and are thus depicted with dashed lines in FIG. 1. By locating connectors 16, 24 within the fabric of garment 10, they may be protected from the elements and prevented from catching on objects with which the user comes into contact or provide other functions. Alternatively, connectors 16, 24 may be located elsewhere. In another embodiment, connectors 16, 24 are omitted. For instance, control panel 14 may communicate with radio device 12 wirelessly; and radio device 12 may communicate with speaker assemblies 18 wirelessly. Still other suitable configurations will be apparent to those of ordinary skill in the art.

In one embodiment, connectors 16, 24 utilize insulated metallic wires. In the present example, connectors 16, 24 comprise copper wire. In another embodiment, connectors 16, 24 comprise electrically conductive fabric. For instance, the electrically conductive fabric may comprise a thin metallic strip mounted on a thin fabric ribbon. Of course, a combination of electrically conductive fabric and copper wire for connectors 16, 24 may also be used. It is also possible to use any other means known in the art to conduct electrical signals between control panel 14 and radio device 12, and from radio device 12 to speaker assemblies 18.

In one embodiment, control panel 14 comprises electrically conductive fabric.

The electrically conductive fabric may comprise a quantum tunneling composite (QTC) and/or other material(s). As described above, control panel 14 may comprise several buttons, each of which is adapted to control a function of radio device 12. In this version, each button may comprise a section of QTC that is connected with one of connectors 16. Application of pressure to a section of QTC may generate an electrical current, or permit passage of an electrical current, that is communicated via connector 16 to radio device 12. Alternatively, application of pressure to a section of QTC may complete a circuit by closing a gap, such that the buttons act as switches. Of course, the buttons may take a variety of alternative forms, including but not limited to electromechanical switches, thin-film switches, any other type of switch, or any other type of button, etc.

As shown in FIG. 1, radio device 12 may be mounted on a chest portion 26 of garment 10. In this location, the weight and bulk of radio device 12 may be less likely to annoy the user or interfere with her activity. However, it is understood that radio device 12 may be located at numerous other locations on garment 10, including but not limited to an upper sleeve area 28.

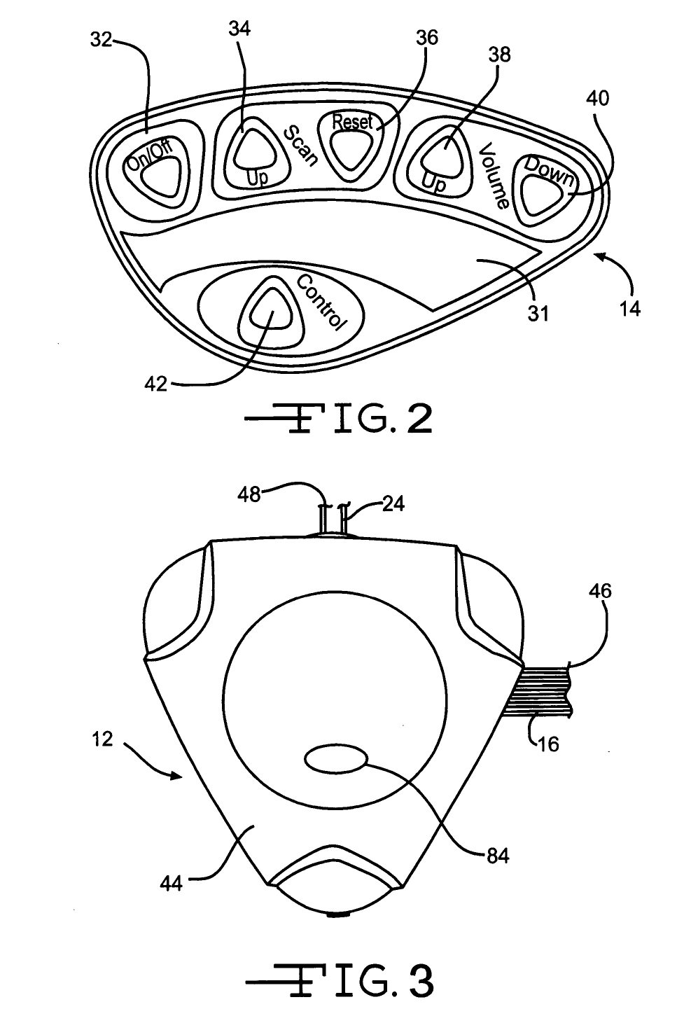

Referring now to FIG. 2, control panel 14 is shown in greater detail. As will be described in more detail below, the top surface of control panel 14 is protected by a soft cover 31. It will be appreciated the bottom surface or any other part of control panel 14 may also have a soft cover 31. In the present example, electronic radio device 12 is a radio, and control panel 14 is operable to control the radio. Radio control panel 14 of this example comprises an on/off button 32, a tuning up button 34, a tuning down button 36 a volume up button 38, and a volume down button 40. In this example, on/off button 32 is operable to turn the radio device 12 on and off.

Control panel 14 and/or radio device 12 may be configured such that on/off button 32 must be depressed for a certain period of time (e.g., three seconds) in order to turn radio device 12 on or off. Tuning buttons 34, 36 are operable to change the frequency setting. Down tuning button 36 also acts as a reset button to return the frequency setting to a default frequency. This resetting function may be provided when down tuning button 36 is actuated for a certain period of time, in combination with actuation of another button, or under any other desired circumstances. Other suitable ways for providing tuning of radio device 12 will be apparent to those of ordinary skill in the art.

Volume buttons 38, 40 are operable to control the volume of the sound output from the radio device 12. Alternatively, the volume control may consist of a single button (not pictured) adapted to cycle through a predetermined number of pre-set volume levels. Other suitable ways for controlling volume will be apparent to those of ordinary skill in the art.

Radio control panel 14 also comprises a control button 42. In the present example, the buttons of radio control panel 14 comprise contact switches. In this embodiment, the user may operate the device by placing one finger on control button 42 and another finger on the contact switch he wishes to actuate, such as on/off button 32. By placing one finger on control button 42 and one finger on on/off button 32, the user's body completes a circuit, communicating an electrical impulse or current through the appropriate connector 16 to radio device 12. In this embodiment, pressing the buttons on control panel 14 will not have any effect unless control button 42 is pressed simultaneously therewith. Of course, control button 42 is merely optional.

In the present example, control panel 14 is comprised of a hard plastic material. In order to facilitate user comfort, as well as to protect the device from damage, garment 10 of the present example incorporates a number of additional features. As mentioned above in reference to control panel 14 as shown in FIG. 2, a soft cover 31 is located over the hard plastic face of control panel 14. In one embodiment, soft cover 31 is made of rubber. Of course, any other material(s) may be used. A foam backing (not pictured) may also be located underneath control panel 14 in order to cushion control panel 14 against the wearer's body. In assembling garment 10, a small hole may be cut into the fabric. Soft cover 31 may then be sewn to garment 10 around the edges of the hole. Control panel 14 may then be secured to the underside of soft cover 31. In one embodiment, control panel 14 is configured to snap into a rib of soft cover 31. The foam backing may then be secured against the underside of control panel 14, such as by double-sided tape or any other suitable means, and sewn to garment 10 and soft cover 31. In this manner, a cushioned “pocket” may be provided for control panel 14. Of course, it is recognized that many alternative methods of and structures for assembling garment 10 may be employed.

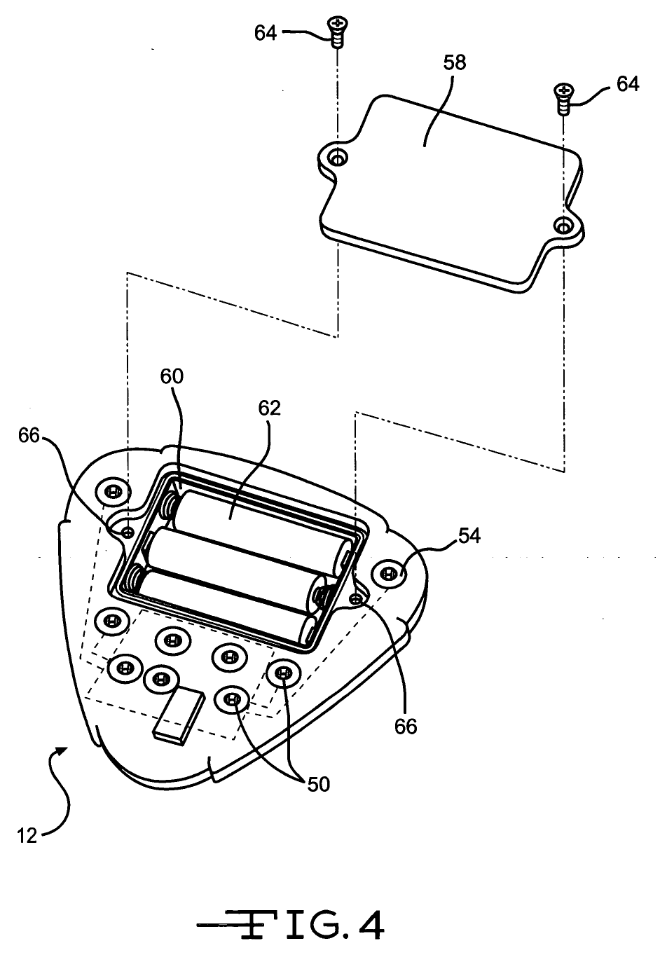

FIG. 3 shows a housing 44 of electronic radio device 12 of the present example. Connectors 16 lead to housing 44 from control panel 14 (not shown in FIG. 3). Connectors 24 lead out of housing 44 toward speaker assemblies 18 (not shown in FIG. 3). Break lines 46, 48 are shown where connectors 16, 24, respectively, may enter the fabric of garment 10. Radio device 12 may further comprise a light 48 in housing 44. Light 84 may be adapted to illuminate when radio device 12 is operating. In addition or in the alternative, light 84 may illuminate when radio device 12 is receiving input from control panel 14. Of course, light 84 may illuminate under any other condition(s), or be eliminated altogether. In one version, light 84 is a light-emitting diode (LED) that converts electrical energy to light. Other suitable types and configurations for light 84 will be apparent to those of ordinary skill in the art.

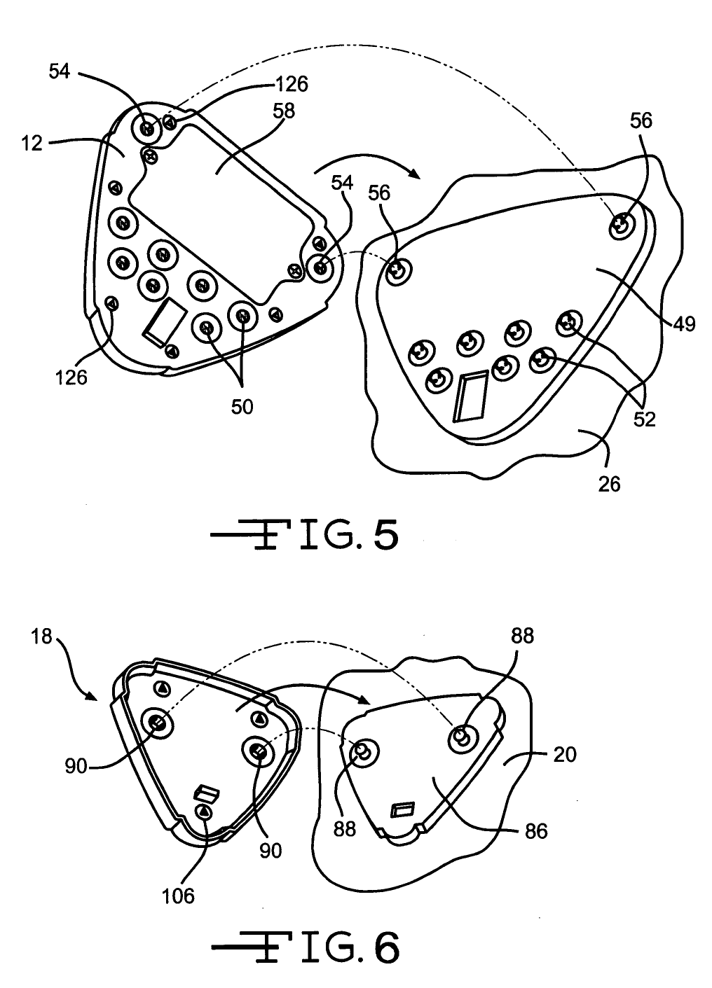

FIGS. 4 and 5 show the rear side of housing 44. In the present example, radio device 12 is battery-powered. Housing 44 includes a removable cover 58. A recess 60 is located below cover 58 for holding batteries 62. As shown in FIG. 4, cover 58 attaches to housing 44 by screws 64 that are adapted to engage screw holes 66. Of course, cover 58 may attach to housing 44 by any means known in the art, or may otherwise be substituted or varied. It will also be appreciated that batteries 62 may be substituted, supplemented, or otherwise varied in any suitable way, and that device may obtain power via any other suitable means.

As shown in FIG. 5, the rear side of housing 44 is configured to detachably mount on a device mounting plate 49 that may be attached to garment 10 (e.g., at the chest portion 26). Device mounting plate 49 may be attached to garment 10 by any method known in the art, including but not limited to sewing or gluing. Housing 44 includes two sets of female snap portions 50, 54, which are configured to engage with male snap portions 52, 56 located on device mounting plate 49. In particular, a first set of female snap portions 50 are configured to engage with a set of male snap portions 52 on device mounting plate 49. Each of male snap portions 52 is in electrical communication with one of connectors 16 leading from control panel 14. A second set of female snap portions 54 are configured to engage with a second set of male snap portions 56 on device mounting plate 49. Each of male snap portions 56 is in electrical communication with one of connectors 24 leading to speaker assemblies 18.

As mentioned above, in one embodiment, speaker assemblies 18 are permanently located within the fabric of garment 10. However, in another embodiment, speaker assemblies 18 are detachably mounted on garment 10.

In this embodiment, speaker assemblies 18 may snap onto garment 10 with mating snaps 80, 88 in a manner similar to that described in regard to the attachment of radio device 12 to garment 10. Referring to FIG. 6, a speaker mounting plate 86 is provided, to which one of speaker assemblies 18 may be mounted. Speaker mounting plate 86 may be attached to garment 10 (e.g., within hood portion 20) through any method of attachment known in the art, including but not limited to sewing or gluing. Speaker mounting plate 86 of this example includes male snap portions 88 that are each in electrical communication with one of connectors 24. Speaker assembly 18 includes female snap portions 90 that are configured to engage with male snap portions 88. Similar to snaps 54, 56, snaps 88, 90 are configured to provide electrical communication from connectors to speaker assembly 18. In this manner, speaker assemblies 18 are configured to receive an output signal from radio device 12 after being mounted to garment 10. However, speaker assemblies 18 may be attached to garment 10 through any other means known in the art that allows speaker assemblies 18 to receive a signal from radio device 12.

As described above with respect to the present example, snaps 50, 52, 54, 56 all serve dual functions of mechanical fastening and electrical communication. Of course, any other suitable features and structures may provide these and other functions. In addition, such features and structures need not serve these functions simultaneously. For instance, in one variation, electrical communication is provided between radio device 12 and connectors 16, 24 by a pin and socket configuration. Other suitable features for providing electrical communication will be apparent to those of ordinary skill in the art. It will also be appreciated that fastening may be provided by a variety of alternative structures, including but not limited to hook-and-pile fasteners, clasps, latches, magnets, and the like. In yet another embodiment, radio device 12 is fixedly secured to garment 10. Still other suitable structures and relationships between radio device 12 and garment will be apparent to those of ordinary skill in the art.

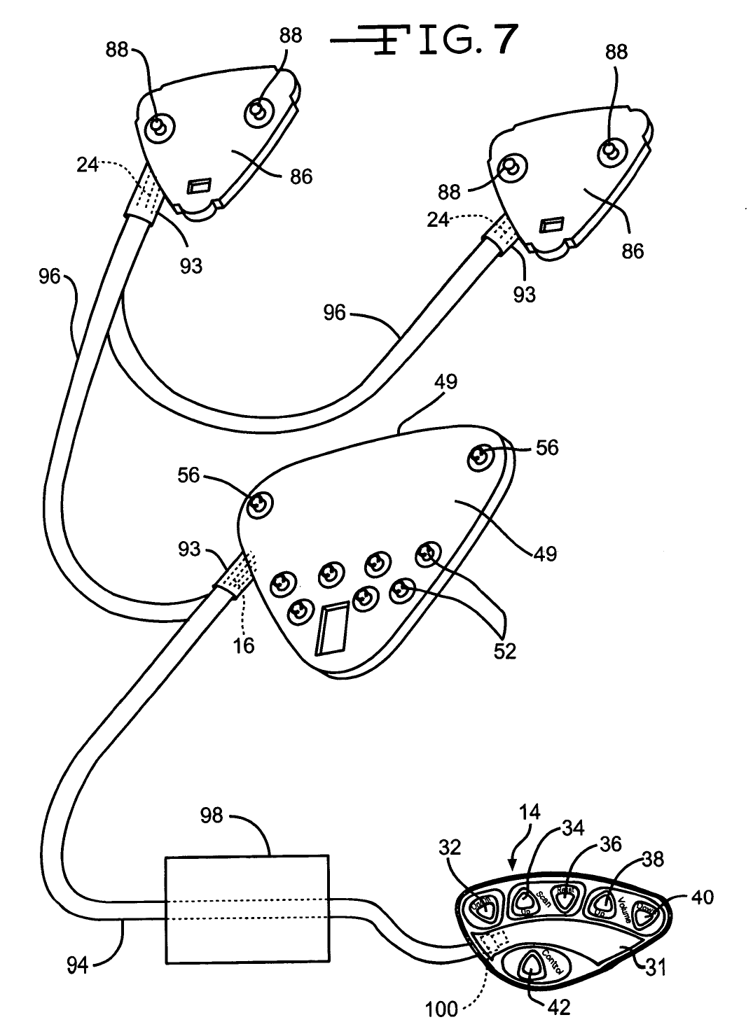

Garment 10 may further incorporate one or more features to protect connectors 16 and connectors 24 from strain or damage. In one embodiment, as shown in FIG. 7, heat shrink tubing 93 is applied to connectors 16 where they exit device mounting plate 49, and to connectors 24 where they exit and speaker mounting plates 86. In one embodiment, in order to make garment 10 more washable, the point of attachment of connectors 16 to device mounting plate 49 and to control panel 14, as well as the point of attachment of connectors 24 to device mounting plate 49 and to speaker assemblies 18, are configured to be watertight. A water-resistant substance, such as glue by way of example only, may also be applied to these points of attachment to make these components more water-resistant. Other techniques for providing or enhancing water resistance will be apparent to those of ordinary skill in the art.

Where connectors 16 lead away from device mounting plate 49, they are grouped together by a cable jacket 94. The cable jacket 94 may help to protect connectors 16 or provide other functions. Similarly, in the present example, connectors 24 are grouped together by a cable jacket 96. Cable jackets 94, 96 may be secured to respective heat shrink tubings 93, such as by glue or any other means; may be secured elsewhere; or may be not secured at all. In one embodiment, cable jackets 94, 96 each comprise a plastic or rubber material. In another embodiment, cable jackets 94, 96 each comprise woven fibers. Still other suitable materials and configurations for cable jackets 94, 96 will be apparent to those of ordinary skill in the art. Alternatively, cable jackets 94, 96 may be eliminated.

In the present example, garment 10 further includes a strain relief element 98 affixed to connectors 16 near the point at which connectors 16 exit control panel 14. Strain relief element 98 is sewn to garment 10 to prevent connectors 16 from being pulled out of control panel 14. In one embodiment, strain relief element 98 is made from KRATON® polymer, which is a soft, pliant polymer.

Of course, any other material(s) may be used. Further, as added protection against undue strain in the present example, an additional strain protection element 100 is attached to connectors 16 and control panel 14 at the point where connectors 16 exit control panel 14. In the present example, strain protection element 100 is made of hard plastic. Other suitable materials for protection element 100 will be apparent to those of ordinary skill in the art. In addition, it will be appreciated that any suitable variation, supplement, or substitute for strain relief element 98 and/or protection element 100 may be used. Alternatively, one or both of strain relief element 98 or protection element 100 may be eliminated.

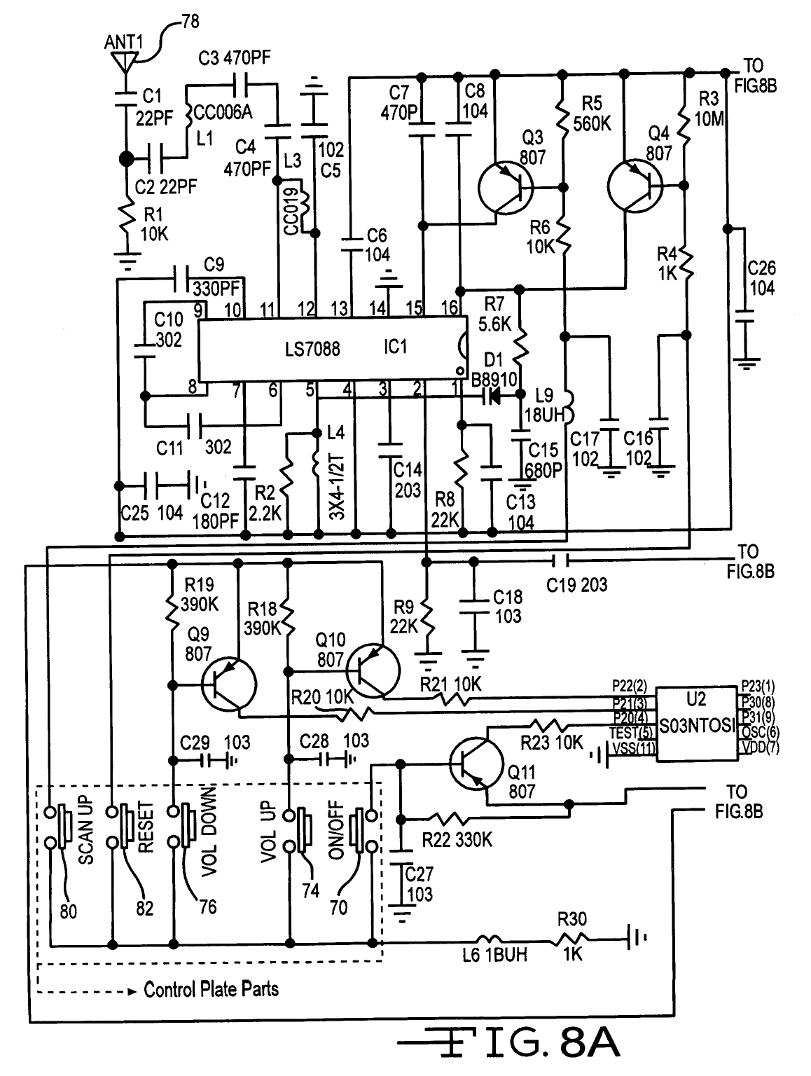

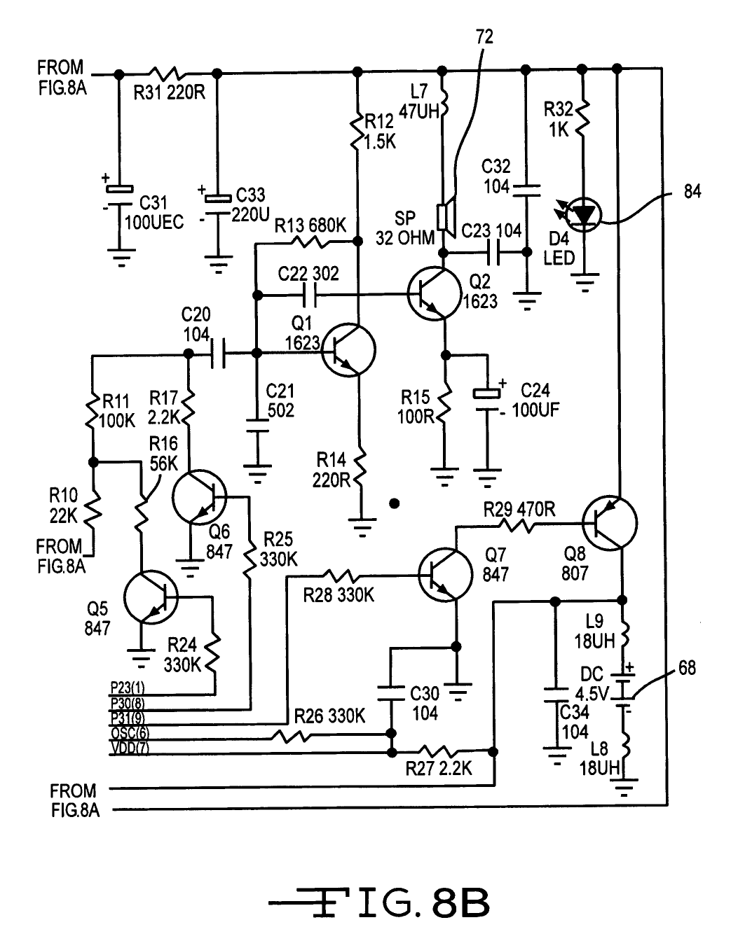

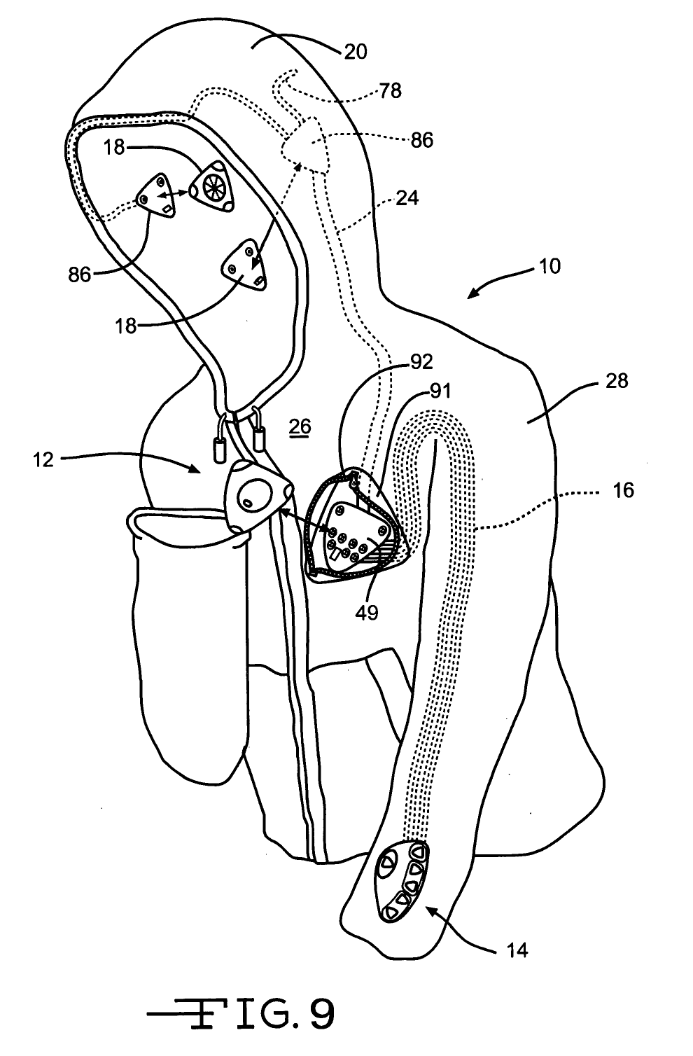

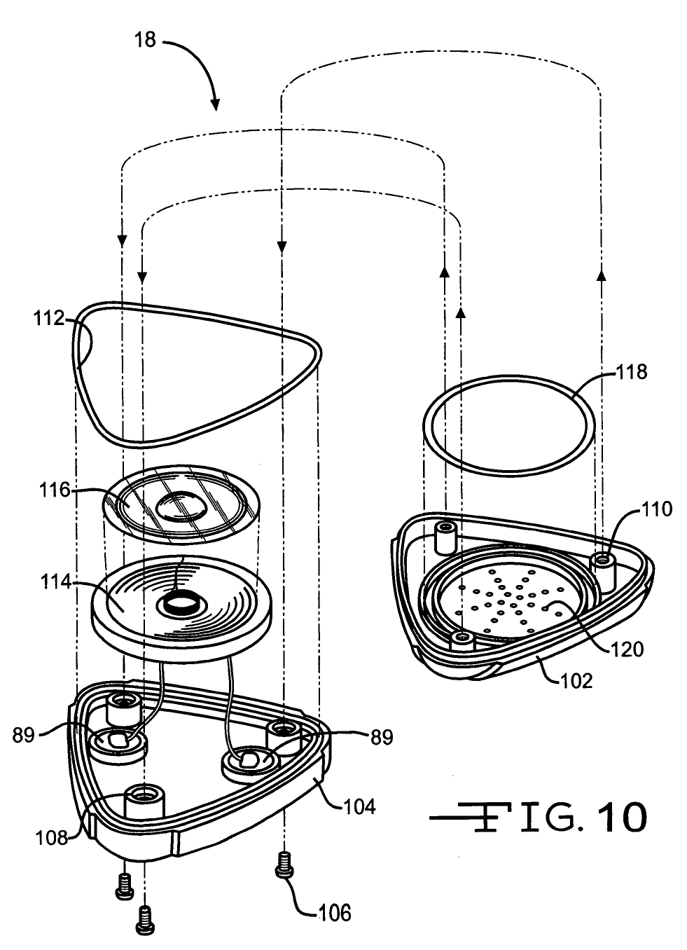

FIGS. 8A and 8B show a sample circuit diagram of the electronic components of one embodiment of the present invention. The diagram is self-explanatory to a person of ordinary skill in the art. However, a number of elements of the diagram are referenced herein. At least one battery 68 is included to provide power to radio device 12. In one embodiment, battery 68 of FIG. 8B comprises batteries 62 of FIG. 4. The circuit comprises an on/off switch 70 to allow the user to provide radio device 12 with power from battery 68. In one embodiment, on/off switch 70 of FIG. 8A comprises on/off button 32 of FIG. 2. At least one speaker 72 is included to convert a signal from radio device 12 from electrical energy to sound. In one embodiment, speaker 72 of FIG. 8B comprises a pair of speaker assemblies 18 as shown in FIG. 9. A volume up switch 74 and a volume down switch 76 are included to allow the user to vary the amplification of the signal that speaker 72 produces. In one embodiment, the volume up switch 74 and the volume down switch 76 of FIG. 8A comprise the volume up button 38 and the volume down button 40 of FIG. 2, respectively. Antenna 78 is included to capture radio signals and introduce them into radio device 12. In the present example, and as shown in FIGS. 1 and 9, antenna 78 is positioned in hood portion 20 of garment 10. Of course, antenna 78 may alternatively be positioned elsewhere.

A scan up switch 80 is also included. In the present example, scan up switch 80 of FIG. 8A comprises scan up button 34 of FIG. 2. Each time scan up switch 80 is closed, the circuit is adapted to change the signal frequency that radio device 12 captures from the environment and outputs through speaker 72 to the next highest signal captured by antenna 78. In this manner, the user may select her desired radio station. A reset switch 82 is included and is operable to reset the circuit to a default frequency when closed. In one embodiment, the default frequency is 87.1 Mhz. In another embodiment, a scan down switch (not pictured) may be provided to change the frequency to the next lowest frequency received by antenna. In this embodiment, reset switch 82 is operable to return the frequency to 107.9 Mhz. It will be appreciated, however, that reset switch 82 may return the frequency elsewhere. In the present example, reset switch 82 of FIG. 8A comprises down tuning button 36 of FIG. 2. Reset switch 82 may also be eliminated.

An LED 84 may also be included. When battery 68 provides power to the circuit, LED 84 may be adapted to convert an electrical signal to light to indicate to the user that radio device 12 is in operation. In the present example, LED 84 is positioned in housing 44 of radio device 12 as shown in FIG. 3. Of course, LED 84 may be positioned elsewhere or otherwise be varied or eliminated.

FIG. 9 shows garment 10 with the components illustrated in FIGS. 2-7. As shown, control panel 14 is secured to sleeve area 28 of garment 10. Speaker mounting plates 86 are secured to opposing sides of the interior of hood 20 of garment 10. Device mounting plate 49 is secured to chest portion 26 of garment 10. As shown, a pocket 91 is provided in chest portion 26 of garment 10, such that device mounting plate 49 is secured within pocket 91. Pocket 91 has a zipper 92 that is operable to open and close pocket. Accordingly, electronic radio device 12 may be secured to device mounting plate 49 in pocket 91, and zipper 92 may then be closed, thereby obscuring, securing, and/or protecting radio device 12 within pocket 91. Of course, pocket 91 may be varied, substituted, or supplemented in any suitable way, if not eliminated altogether. Still other ways in which garment 10 shown in FIG. 9 may be varied will be apparent to those of ordinary skill in the art.

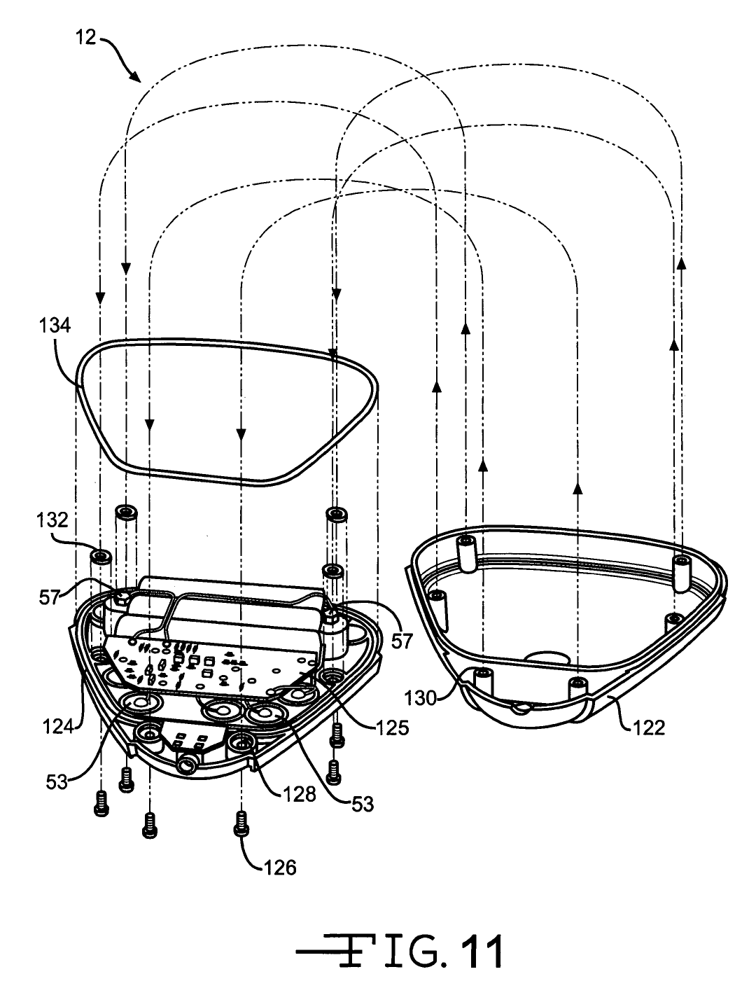

FIG. 10 shows various exemplary components of speaker assembly 18. As shown, speaker assembly 18 comprises a front portion 102 and a rear portion 104. Front portion 102 comprises posts 110, and rear portion 104 comprises recess posts 108. Posts 110 are configured to engageably fit with recess posts 108. A screw 106 is inserted trough the rear of rear portion 104, through the center of each recess post 108, and screwed into the center of each post 108. Screws 106, posts 110, and recess posts 108 are thus configured to secure front portion 102 and rear portion 104 together. Of course, Front portion 102 and rear portion 104 may be secured together in any other suitable way. In the present example, a gasket 112 is provided between front portion 102 and rear portion 104. Gasket 112 of the present example comprises a rubber material, though any other material(s) may be used. Gasket 112 is configured to resist entry of water, moisture, and the like through the interface of front portion 102 and rear portion 104. Gasket 112 may thus provide some degree of water resistance for speaker assembly 18. In another embodiment, gasket 112 is substituted or supplemented with an adhesive. Still other ways in which water resistance may be provided will be apparent to those of ordinary skill in the art.

Speaker assembly 18 further comprises a speaker 114, which is a conventional speaker. Rear portion 104 further comprises terminals 89, each of which are provided the rear side of snaps 90. Speaker 114 is connected to each of terminals 89, thus providing electrical communication between snaps 90 and speaker 114. A film 116 is provided on top of speaker 114. In one embodiment, film 116 comprises MYLAR® material. Of course, any other type of material(s) may be used. In the present example, film 116 is configured to protect speaker 114 from water damage. Film 116 may thus provide some degree of water resistance for speaker 114. Other ways in which water resistance may be provided will be apparent to those of ordinary skill in the art. In one embodiment, film 116 has little, if any, adverse impact on the communicability of sound from speaker 114. It will be appreciated that film 116 may comprise a diaphragm, membrane, or any other structure.

Top portion 102 of speaker assembly 18 further comprises a plurality of openings 120. Openings 120 are configured to facilitate communication of sound from speaker 114 through top portion 102. An o-ring 118 is provided adjacent top portion 102 near openings 120. O-ring 118 of the present example comprises a rubber material, though any other material(s) may be used. O-ring 118 is configured to provide some degree of resistance against water, moisture, etc. that enters speaker assembly 102 through openings 120, such as to prevent such water, moisture, etc. from entering other portions of speaker assembly 18. Of course, any suitable variation, supplement, or substitute for o-ring 118 may be used.

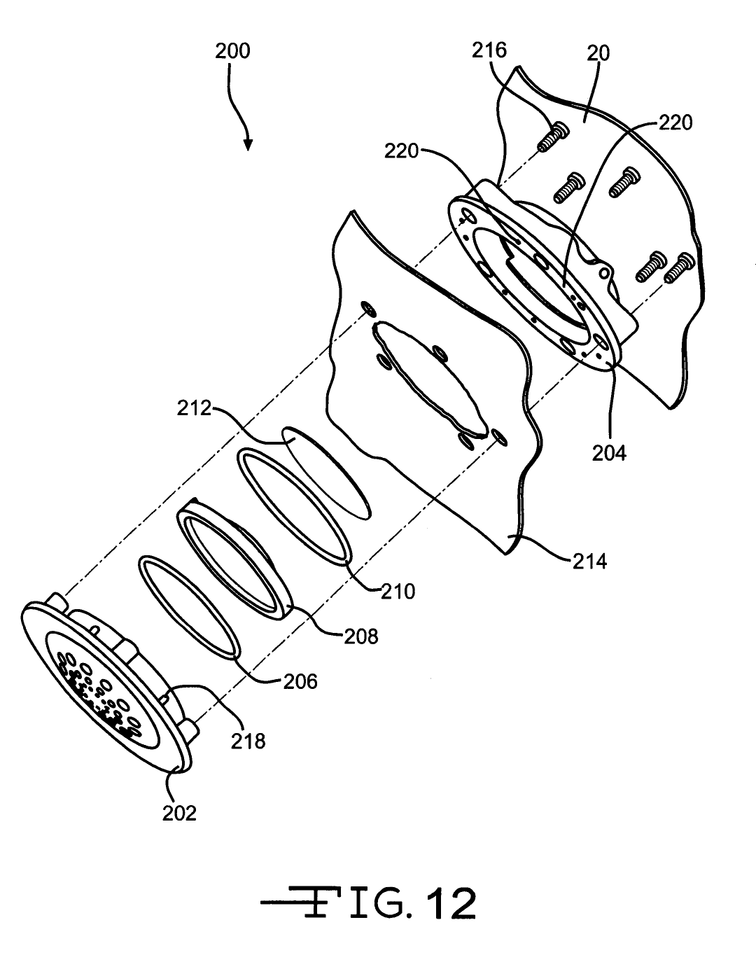

FIG. 11 shows various exemplary components of radio device 12. As shown, radio device 12 comprises a front portion 122 and a rear portion 124. Front portion 122 comprises posts 130, and rear portion 124 comprises recess posts 128. Posts 130 are configured to engageably fit with recess posts 128. A screw 126 is inserted trough the rear of rear portion 124, through the center of each recess post 128, and screwed into the center of each post 128. Screws 126, posts 130, and recess posts 128 are thus configured to secure front portion 122 and rear portion 124 together. Of course, Front portion 122 and rear portion 124 may be secured together in any other suitable way. In the present example, a gasket 134 is provided between front portion 122 and rear portion 124. Gasket 134 of the present example comprises a rubber material, although any other material(s) may be used. Gasket 134 is configured to resist entry of water, moisture, and the like through the interface of front portion 122 and rear portion 124. Gasket 134 may thus provide some degree of water resistance for radio device 12. In another embodiment, gasket 134 is substituted or supplemented with an adhesive. Still other ways in which water resistance may be provided will be apparent to those of ordinary skill in the art.

Radio device 12 further comprises circuit board 125, where a many of the components illustrated in FIGS. 8A-8B reside. Rear portion 104 further comprises terminals 53 and 57, which are provided adjacent to the rear side of snaps 50 and 54, respectively. Circuit board 125 is connected to each of terminals 53 and 57, thus providing electrical communication between snaps 50 and 54 and circuit board 125. Of course, any other suitable configuration may be used.

Radio device 12 further comprises a plurality of washers 132. Each washer 132 is configured to fit at the interface between each post 130 and corresponding recess post 128. In one embodiment, washers 132 comprise a rubber material. In another embodiment, washers 132 comprise a metal material. Of course, any other type of material(s) may be used. Washers 132 are configured to provide some degree of resistance to water, moisture, etc. entering though interface between each post 130 and corresponding recess post 128. In another embodiment, washers 132 are substituted or supplemented with an adhesive. Still other ways in which water resistance may be provided will be apparent to those of ordinary skill in the art.

FIG. 12 shows a speaker assembly 200, which is an alternative to speaker assembly 18. As shown, speaker assembly 200 comprises a front member 202 and a rear member 204. Front member 202 comprises a plurality of protrusions 218 protruding therefrom. In one embodiment, protrusions 218 comprise a plurality of teeth. Of course, protrusions 218 may take a variety of alternative of forms, as will be apparent to those of ordinary skill in the art. It will also be appreciated that protrusions 218 may be substituted or supplemented in a variety of ways.

Rear member 204 comprises a plurality of openings 220 configured to receive protrusions 218. In addition, a piece of fabric 214 is provided. Front member 202 and rear member 204 may be secured to fabric 214 by essentially “sandwiching” the fabric 214. It will be appreciated that, with fabric 214 so positioned between front member 202 and rear member 204, protrusions 218 may pass through fabric 214 and/or push portions of fabric 214 into recesses 220. In such a configuration, screws 216 may be inserted through the back of rear member 204 to secure rear member 204 to front member 202. In the present example, with front member 202 and rear member 204 secured together with screws 216, and with fabric 214 positioned between front member 202 and rear member 204, speaker assembly 200 will be secured to fabric 214. In such a configuration, engagement of fabric 214 between and/or adjacent to protrusions 218 and recesses 220 may enhance the securing of speaker assembly 200 to fabric 214. Of course, any other features, configurations, or devices may be used to effect or enhance the securing of speaker assembly 200 to fabric 214.

Speaker assembly 200 of the present example further comprises a speaker 208, which is positioned between two O-rings 206 and 210. A membrane 212 is sealed to the rear portion of speaker 208. In addition or in the alternative, membrane 212 may be sealed to rear member 204 or elsewhere. Membrane 212 may be flexible, and may comprise GORE-TEX® or any other suitable material(s). Membrane 212 may be sealed to the rear portion of speaker 208 or elsewhere using an adhesive, ultrasonic welding, and/or any other device or technique. All of O-rings 206 and 210, speaker 208, and membrane 212 may be positioned between front member 202 and rear member 204. It will be appreciated that o-rings 206 and 210 and membrane 212 may provide resistance to water, moisture, etc., thereby protecting speaker 208. In addition, connectors 24 (not shown) may also be sealed. It will therefore be appreciated that speaker assembly 200 may be substantially water resistant, such that water, moisture, etc. will not adversely affect performance of speaker 208.

With speaker assembly 200 assembled, including fabric 214 securably positioned between front member 202 and rear member 204, fabric 214 may be sewn or otherwise secured to garment 10. For instance, and by way of example only, fabric 214 may be sewn to hood 20, thereby substantially securing speaker assembly 200 to hood 20. Of course, speaker assembly 200 may be secured to hood 20 or elsewhere in a variety of alternative ways.

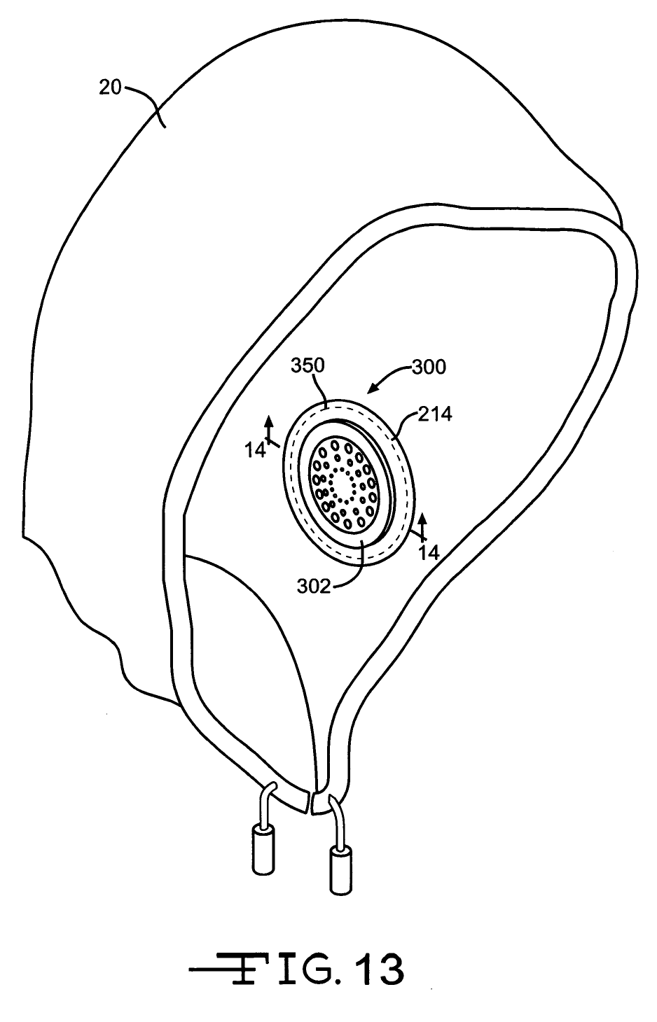

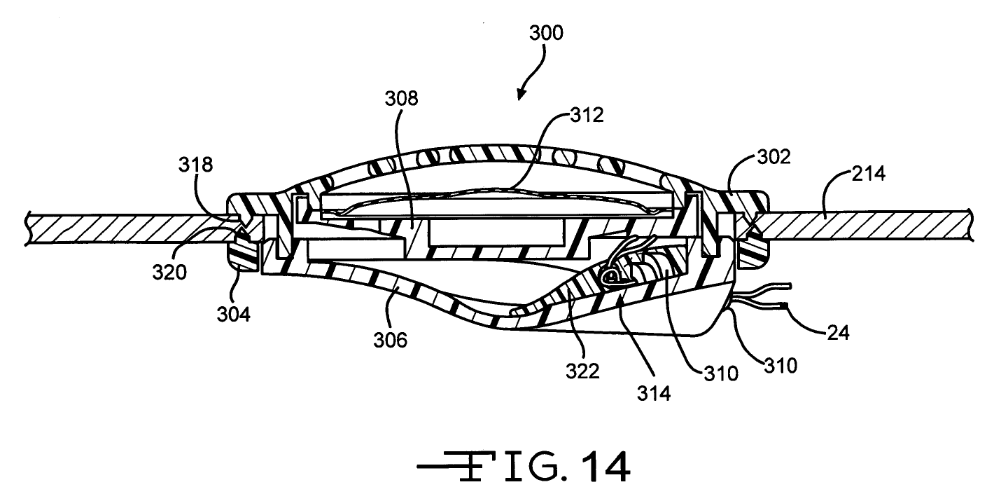

FIG. 13 shows yet another speaker assembly 300, which is a variation of speaker assembly 200, secured to hood 200. As shown, fabric 214 is sewn to hood 20 by stitching 350, such that a front member 302 of speaker assembly 300 may be seen while other components of speaker assembly 300 are hidden.

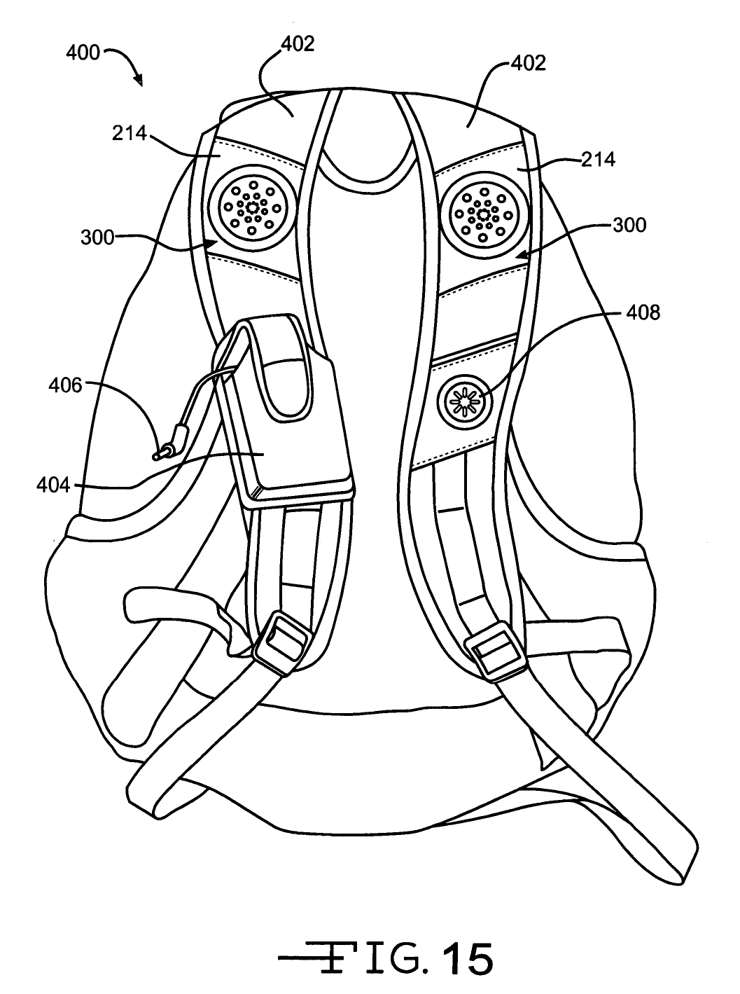

FIG. 14 shows a cross-sectional view of speaker assembly 300. As shown, speaker assembly 300 comprises a front member 302, a rear member 304, and a rear cover 306. Similar to front member 202 shown in FIG. 12, front member 302 shown in FIG. 14 has a plurality of protrusions 318 protruding therefrom. Rear member 304 also has a plurality of protrusions 320 protruding therefrom. In one embodiment, protrusions 318 and 320 comprise a plurality of teeth. Of course, protrusions 318 and 320 may take a variety of alternative of forms, as will be apparent to those of ordinary skill in the art. It will also be appreciated that protrusions 318 and 320 may be substituted or supplemented in a variety of ways. Similarly, protrusions 318 may differ from protrusions 320.

The protrusions 318 and 320 of the present example are configured to engage fabric 214 when fabric 214 is “sandwiched” between front member 302 and rear member 304. In one embodiment, rear member 304 may be secured to front member 302 with a plurality of screws (not shown). In another embodiment, rear member 304 may be secured to front member 302 with one or more clipping members (not shown). Alternatively, any other devices, structures, or techniques for securing front member 302 relative to rear member 304 may be used. It will also be appreciated that front member 302 and rear member need not actually engage with each other to effect such relative securing.

In one embodiment, rear member 304 comprises a generally annular member. In another embodiment, rear member 304 has a generally circular inner perimeter, with a generally triangular outer perimeter. Similarly, front member 302 may have a generally triangular outer perimeter that compliments the outer perimeter of rear member 304. In this example, a screw or other fastener is located in the general region of the corners of the triangles. For instance, a screw may be passed through front member 302 and secured within rear member 304, or vice-versa, near each corner region of the triangular perimeter of front and rear members 302 and 304. Of course, rear member 304 and front member 302 may take a variety of alternative forms, and may be secured relative one another in any other way.

Rear cover 306 of speaker assembly 300 may be secured to one or both of front member 302 and/or rear member 304. By way of example only, rear cover 306 may be so secured using one or more fasteners, clipping components, adhesives, ultrasonic welding, or using any other techniques, including combinations thereof. For instance, in one embodiment, rear cover 306 is ultrasonically welded to front member 302. In another embodiment, glue is added to an interface where rear cover 306 is ultrasonically welded to front member 302. Of course, rear cover 306 may be secured to any component of speaker assembly 300 using any other device, structure, or techniques, including combinations thereof.

In one embodiment, rear cover 306 comprises a plastic material. Of course, any other type of material may be used. In another embodiment, rear member 304 is integrally formed with rear cover 306. For instance, rear member 304 and rear cover 306 may comprise a homogenous continuum of material. In the present example, a gasket 310 is positioned in rear cover 306. Connectors 24 pass through gasket 310 to reach speaker 308, which is contained within speaker assembly 300. It will be appreciated that gasket 310 may provide some degree of resistance to water, moisture, etc. entering through rear cover 306 adjacent connectors 24. In the present example, an optional knot 314 is also provided in connectors 24 to resist strain that may urge connectors 24 to be pulled through gasket 310. In addition, glue 322 is added to provide an additional seal at the interface of connectors 24 and gasket 310. Glue 322 may also assist knot 314 in resisting strain on connectors 24 that may urge connectors 24 to be pulled through gasket 310. Of course, knot 314, glue 322, and gasket 310 are all optional, and may be varied, substituted, or supplemented in any suitable way.

A film 312 is positioned over speaker 308 in FIG. 14. Film 312 may comprise MYLAR® and/or any other suitable material. Film 312 may provide some resistance to water, moisture, etc. entering through front cover 302 or elsewhere. It will be appreciated that film 312 may be glued to speaker 308 or otherwise secured thereto. It will also be appreciated that one or both of speaker 308 and/or film 312 may be glued, welded (e.g., ultrasonically), or otherwise secured to front member 302 or elsewhere. In addition, it will be appreciated that film 312 may comprise a diaphragm, membrane, or any other structure.

As described above, speaker assembly 300 may be assembled with fabric 214 positioned between front member 302 and rear member 304. With front member 302 and rear member 304 secured relative one another, protrusions 318 and 320 in the present example grip fabric 214, such that speaker assembly 300 is substantially secured to fabric 214. Fabric 214 may then be sewn on to a hood 20 using stitching 350, thereby securing speaker assembly 300 to hood 20. Of course, speaker assembly 300 may be secured to any other region of any other type of garment using any other suitable device, structures, or techniques.

To illustrate how speaker assembly 300 may be used on a variety of types of garments, FIG. 15 shows speaker assembly 300 secured to a backpack 400. Backpack 400 has a pair of straps 402, and a speaker assembly 300 is secured to each of the straps 402. As shown, this securing is accomplished by fabric 214 being sewn to the straps 402. In this example, connectors such as wires (not shown) pass through straps 402 to reach other components of the system. The backpack 400 of FIG. 15 further comprises a pocket 404. Pocket 404 is dimensioned such that a variety of devices may fit therein, including but not limited to IPODs and other MP3 players. A jack 406 extends into or out of pocket 404, and is configured to receive output from a device such as one of the audio devices mentioned above. The jack 406 is in electrical communication with speaker assemblies 300, such that output from an audio device that is coupled with jack 406 may be heard through speaker assemblies 300.

Backpack 400 shown in FIG. 15 further comprises a volume knob 408 positioned in strap 402. In this example, volume knob 408 is operable to control the volume level of sound communicated through speaker assemblies 300. In another embodiment, volume knob 408 is substituted with a control pad (not shown), such as the control pad 14 illustrated in FIGS. 1, 2, 7, and 9. It will also be appreciated that backpack 400 may further comprise a radio device (not shown), such as the radio device 12 shown in FIGS. 1, 3-5, 9, and 11. Backpack 400 may also have a portion configured to receive batteries, an amplifier, or any other devices or components. In yet another embodiment, backpack 400 further comprises a headphone jack (not shown). In this embodiment, headphone jack may provide a bypass to speaker assemblies 300, such that speaker assemblies 300 will not emit sound when headphones are plugged into the headphone jack. Of course, the above-described components of backpack 400 described above may be modified, substituted, omitted, or supplemented in any way. It will also be appreciated that backpack may comprise a variety of other components.

Several components described herein, including but not limited to radio device 12, control panel 14, and speaker assemblies 18, 200, and 300, have been described as having a degree of water resistance. It will be appreciated that such water resistance may permit a garment 10 (including backpack 400) to be laundered in the normal course with the components secured thereto or therein. In other words, these components may be configured such that being washed and dried in a conventional washer and dryer will not adversely affect the performance of the components. Such results may be obtained using the structures and techniques described herein, or by using variations thereof. Those of ordinary skill will appreciate, however, that having such properties is not required of components, and that non-washable, non-dryable components are also explicitly contemplated herein.

Having shown and described various embodiments and concepts of the invention, further adaptations of the methods and systems described herein can be accomplished by appropriate modifications by one of ordinary skill in the art without departing from the scope of the invention. Several of such potential alternatives, modifications, and variations have been mentioned, and others will be apparent to those skilled in the art in light of the foregoing teachings. Accordingly, the invention is intended to embrace all such alternatives, modifications and variations as may fall within the spirit and scope of the appended claims and is understood not to be limited to the details of structure and operation shown and described in the specification and drawings.

What is claimed is:

1. A wearable sound system, comprising:
(a) a garment; and
(b) a speaker assembly, wherein the speaker assembly is configured to substantially resist water, wherein the speaker assembly comprises:
(i) a first member having an inner portion and an outer portion,
(ii) a second member having an inner portion and an outer portion, wherein the second member is secured to the first member, wherein the second member is positioned adjacent to the garment,
(iii) a fabric member, wherein the fabric member is positioned between the outer portion of the first member and the outer portion of the second member, wherein the fabric member is secured to the garment, and
(iv) a speaker, wherein the speaker is operable to convert electrical signals to audible sounds, wherein the speaker is positioned within the inner portion of the first member.

2. The wearable sound system of claim 1, wherein the garment has a hood.

3. The wearable sound system of claim 2, wherein the speaker assembly is positioned within the hood.

4. The wearable sound system of claim 1, wherein the garment is a backpack having shoulder straps.

5. The wearable sound system of claim 4, further comprising a second speaker assembly, the second speaker assembly comprising:
(i) a first member having an inner portion and an outer portion,
(ii) a second member having an inner portion and an outer portion, wherein the second member is secured to the first member,
(iii) a fabric member, wherein the fabric member is positioned between the outer portion of the first member and the outer portion of the second member, wherein the fabric member is secured to the garment, and
(iv) a speaker, wherein the speaker is operable to convert electrical signals to audible sounds, wherein the speaker is positioned within the inner portion of the first member;
wherein the fabric member of each speaker assembly is secured to a respective one of the shoulder straps.

6. The wearable sound system of claim 1, further comprising an audio source in communication with the speaker, wherein the audio source is integral with the garment.

7. A speaker assembly configured to be secured to a garment, wherein the speaker assembly comprises:
(a) a front member having an inner portion and an outer portion;
(b) a rear member having an inner portion and an outer portion, wherein the front member and the rear member are secured together;
(c) a rear cover secured to the front member, wherein the rear cover is positioned within the inner portion of the rear member;
(d) a speaker, wherein the speaker is operable to convert electrical signals to audible sounds, wherein the speaker is positioned within the inner portion of the front member; and
(e) a fabric member, wherein the fabric member is positioned between the outer portion of the front member and the outer portion of the rear member, wherein the fabric member is configured to be secured to a garment;
wherein the speaker assembly is configured to substantially resist water.

8. The speaker assembly of claim 7, wherein the rear cover is secured to the front member with ultrasonic welding.

9. The speaker assembly of claim 7, wherein each of the front member and the rear member comprise a plurality of protrusions engaged with the fabric member, wherein the protrusions are configured to grip the fabric member.

10. The speaker assembly of claim 7, wherein the rear member is secured to the front member with a plurality of screws.

11. The speaker assembly of claim 7, further comprising a wire in electronic communication with the speaker.

12. The speaker assembly of claim 11, wherein the wire passes through the rear cover.

13. The speaker assembly of claim 12, wherein the rear cover comprises a gasket, wherein the wire passes through the gasket of the rear cover.

14. The speaker assembly of claim 13, wherein the rear cover further comprises an adhesive positioned adjacent the gasket and the wire.

15. The speaker assembly of claim 12, wherein the wire comprises a knot positioned adjacent the rear cover.

16. A wearable sound system, comprising:
(a) a garment;
(b) a speaker assembly, wherein the speaker assembly is configured to substantially resist water, wherein the speaker assembly comprises:
(i) a first member having an inner portion and an outer portion,
(ii) a second member having an inner portion and an outer portion, wherein the second member is secured to the first member,
(iii) a fabric member, wherein the fabric member is positioned between the outer portion of the first member and the outer portion of the second member, wherein the fabric member is secured to the garment, and
(iv) a speaker, wherein the speaker is operable to convert electrical signals to audible sounds, wherein the speaker is positioned within the inner portion of the first member; and
(c) a means for communicating electronic audio signals to the speaker.

17. The wearable sound system of claim 16, wherein the means for communicating electronic audio signals to the speaker comprises a radio device.

18. The wearable sound system of, claim 16, wherein the means for communicating electronic audio signals to the speaker comprises a jack configured to receive an output from an audio device.

19. The wearable sound system of claim 16, further comprising a control panel, wherein the control panel is operable to control an audio signal communicated to the speaker.

20. The wearable sound system of claim 19, wherein the control panel is integral with the garment.
